(19) United States
(12) Patent Application Publication
(10) Pub. No.: US 2019/0332789 A1
(43) Pub. Date: Oct. 31, 2019

(54) HIERARCHICAL ACCESS RIGHTS AND ROLE BASED ACCESS

(71) Applicant: MICROSOFT TECHNOLOGY LICENSING, LLC, Redmond, WA (US)

(72) Inventors: Grégory Christopher John VANDENBROUCK, Bellevue, WA (US); Hubert VAN HOOF, Bellevue, WA (US); Yurui ZHOU, Seattle, WA (US); Eric Alexander POGASH, Kirkland, WA (US); Daniel ESCAPA, Seattle, WA (US); David John BRENNAN, Redmond, WA (US)

(21) Appl. No.: 15/964,754

(22) Filed: Apr. 27, 2018

(51) Int. Cl. G06F 21/62; G06F 21/60; H04L 29/06

(52) U.S. Cl. CPC G06F 21/6218; G06F 21/604; G06F 2221/2141; G06F 2221/2145; H04L 63/102

(57) ABSTRACT

Enforcing role assignment permissions. A method includes receiving an access request from a given role entity for access to a resource. A hierarchical graph that defines a topology for an entity is accessed to determine a given node associated with the given role entity. One or more ancestor permissions, applying to nodes hierarchically higher in the graph than the given node, and one or more local permission, applying to nodes hierarchically lower in the graph than the given node, are accessed. The method includes determining that the role entity has permission from at least one of the ancestor permissions or the local permissions to perform the access in the access request on the resource. As a result, the role entity is allowed to perform the access in the access request, on the resource.

### BACKGROUND

### Background and Relevant Art

Computers and computing systems have affected nearly every aspect of modern living. Computers are generally involved in work, recreation, healthcare, transportation, entertainment, household management, etc. A computing system can be manifested through a variety of form factors such as computers, laptops, smartphones, gateways, controllers, IoT devices and sensors

Further, computing system functionality can be enhanced by a computing systems' ability to be interconnected to other computing systems via network connections. Network connections may include, but are not limited to, connections via wired or wireless Ethernet, wireless mesh networks, cellular connections, or even computer to computer connections through serial, parallel, USB, or other connections via a wide variety of protocols (such as, but not limited to, MQTT, AMQP, http, Bluetooth, OPC-UA, SCADA, CoAP, BACnet, Modbus, KNX, LonTalk, Zigbee, Zwave, Sigfox, LoRa, etc.), some of which are industry or domain specific. The connections allow a computing system to access services at other computing systems and to quickly and efficiently receive data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

In a cloud-based environment, access to resources can be complicated. In particular, there are certain resources which should be exclusively for use by some entities, but where use should be entirely excluded for other entities. For other resources, some entities should have unlimited, or nearly unlimited access, while other entities should have limited access. For example, an administrator of the cloud-based service should be able to read and write to certain resources, whereas tenants of the cloud-based service should only be allowed to read the certain resources. However, management of permissions to allow this can be complex.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for enforcing role assignment permissions. The method includes receiving an access request from a given role entity for access to a resource. A hierarchical graph that defines a topology for an entity is accessed to determine a given node associated with the given role entity. The hierarchical graph includes a top node for the entity and a plurality of branches coupled, through 0 or more intermediate nodes, to the top node of the entity. Each of the branches in the graph represents a sub-entity. One or more ancestor permissions for the given role entity at the given node in the hierarchical graph are accessed. The one or more ancestor permissions apply to nodes hierarchically higher in the graph than the given node. One or more local permission for the given role entity at the given node in the hierarchical graph are accessed. The one or more local permissions apply to nodes hierarchically lower in the graph than the given node. The method includes determining that the role entity has permission from at least one of the ancestor permissions or the local permissions to perform the access in the access request on the resource. As a result, the role entity is allowed to perform the access in the access request, on the resource.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computer architecture that facilitates operation of the principles described herein.

FIG. 2 illustrates an example environment for providing access to sensor data from devices within a physical space.

FIG. 3 illustrates an example hierarchical graph associated with a physical space.

FIG. 4 illustrates an example hierarchical graph associated with a physical space and devices associated with areas or sub-areas of the physical space.

FIG. 5 illustrates a flowchart of a method for providing access to sensor data from devices within a physical space.

FIG. 6 illustrates a system for enforcing role entity permissions.

FIG. 7 illustrates an example hierarchical graph for a tenant of a cloud service.

FIG. 8 illustrates a flowchart of a method for enforcing role entity assignment permissions.

### DETAILED DESCRIPTION

The application is generally directed to a system that uses a hierarchical graph that defines a topology for an entity. The hierarchical graph has a top node for the entity and a plurality of branches coupled, through 0 or more intermediate nodes, to the top node of the entity. Each of the branches (including individual nodes) in the graph represents a sub-entity.

Role entities are entities that can have access to certain resources in the entity. Access to certain resources can take one or more of several different forms. For example, a resource may be storage, such as computer memory or mass storage. Access can be granted to certain portions of the storage, such as certain data structures stored in the storage. The access permissions could be read only access, read/write access, or some other access. Additionally, different access permissions could be granted to the same role entity for different portions of data structure. Thus, for example, a role entity may have read/write permissions to change property values of an object, but may not have permissions to add new properties to the object.

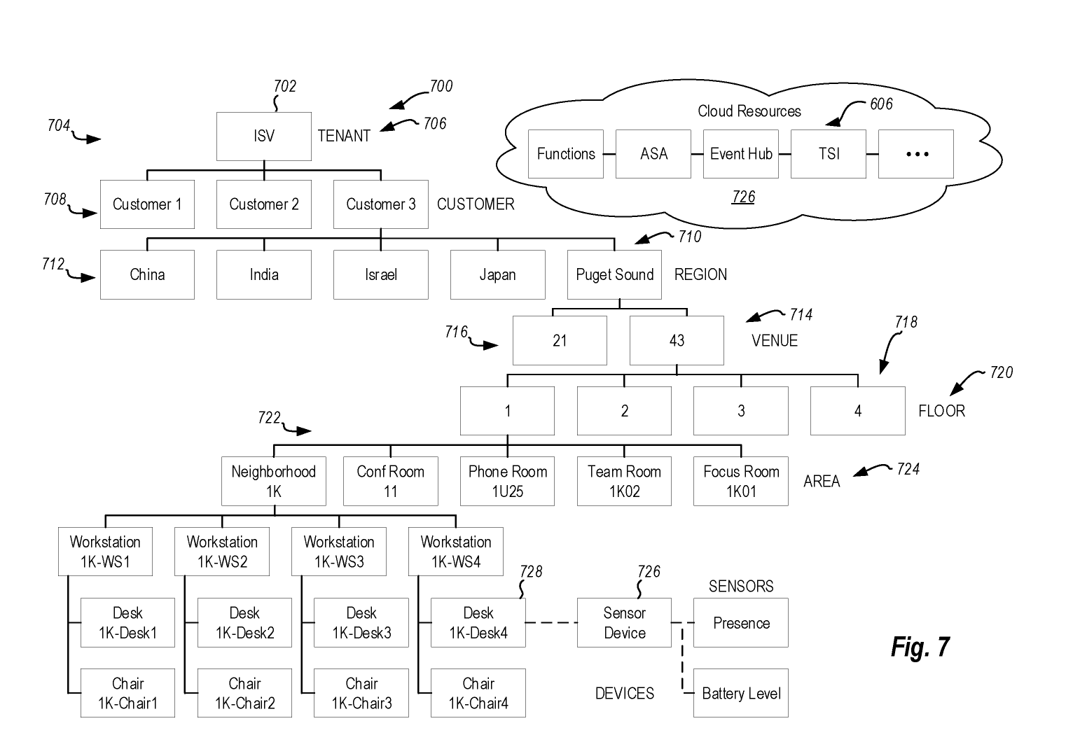

Embodiment are implemented where a given role entity can be assigned given role assignments defining their access permissions. The role entity can be assigned both ancestor and local role assignments. Each ancestor role assignment defines one or more ancestor permissions for a given role entity at a given node in the hierarchical graph. The one or more ancestor permissions apply to nodes hierarchically higher in the graph than the given node. For example, reference is made to FIG. 7, which illustrates a hierarchical graph 700. If an ancestor read permission were granted to a role entity at the node 43 in the venue level 714, then that read permission would apply to the Puget Sound node in the region level 710, the customer 3 node in the customer level 706, and the tenant node 702. In some embodiments, the ancestor permissions only apply upward in the graph, and do not apply downward. Thus, the role entity would not be granted read permissions for the 1-4 nodes in the floor level, or other or other nodes hierarchically below the 43 node by virtue of the ancestor permission assignment. Note that in some embodiments, the ancestor permissions may apply to the given node as well as to nodes upward in the graph. However, typically, the ancestor permissions will only apply to nodes upward in the graph.

Each local role assignment defines one or more local permission for the given role entity at the given node in the hierarchical graph. The one or more local permissions apply to nodes hierarchically lower in the graph than the given node. Thus, continuing the present example, if a local read/write permission is granted to the role entity at node 43 in the venue level 714, then that read/write permission would apply to all of the nodes in the branch the includes node 43 downward. Thus, typically, the local permissions apply to the given node as well as to nodes hierarchically lower in the graph than the given node. Thus, all of the nodes shown in the floor level 720, the area level 724 and so forth. Note that nodes for other branches are not shown, and that the local permissions would not apply to these other branches. Thus, for example, the permissions would not apply for the role entity in a branch from node 21 in the venue level 714 downward. Additionally, the local permissions only apply downward in the graph, and do not apply upward. Thus, the role entity would not be granted read/write permissions for the Puget Sound node, or other nodes hierarchically above the 43 node by virtue of the local permission assignment.

Embodiments illustrated herein can be used to implement an improved computing system by improving performance with respect to how permissions to resources are granted. In particular, permissions can be defined in a more compact, concise, and precise way compared to previous system, in that two different types of permissions can be defined for an entity using a computing system storing a hierarchical graph, by defining the different type of permissions for a node in the graph. Using the computing system, the permissions can be accessed, and thus applied in a more efficient manner, improving the computing system.

A description of a computing system where embodiments may be implemented, followed by a description of how hierarchical graphing of an entity may be accomplished will now be presented.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

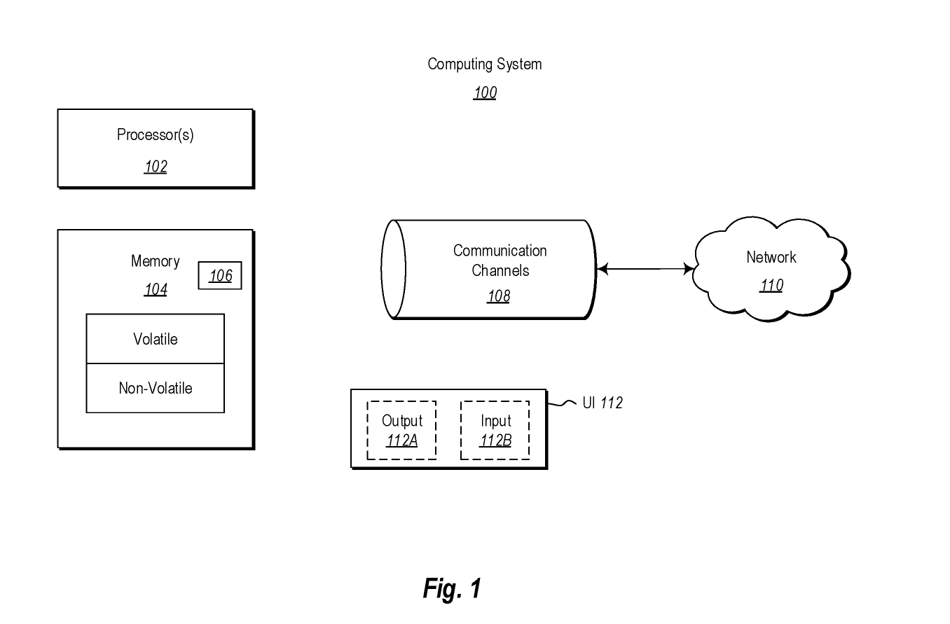

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “control”, or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes NAND flash memory or other flash memory, RAM, DRAM, SRAM, ROM, EEPROM, CD-ROM or other optical disk storage, solid-state disk storage, magnetic disk storage or other storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, traditional computing systems such as smartphones, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses, watches, etc.) and the like. In modern computing systems, in the age of Internet of Things (IoT), computing system configurations may be virtually any type of device including (but most certainly not limited to) smart luggage, smart jewelry, smart drinking bottles, smart skate boards, smart golf clubs, smart toys, smart brewing machines, smart wallets, smart home and business automation gear, smart appliances, smart furniture, etc. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Reference is made frequently herein to IoT devices. As used herein, an IoT device can include any device that is connected to a network (whether that be a personal area network, local area network, wide area network, and/or the Internet) and that interacts with a physical environment (whether that be to control or influence some aspect of a physical environment, and/or to receive sensor data from a physical environment). As such, references to IoT devices herein should be interpreted broadly to include vast categories of devices, regardless of how those devices may be named or marketed. From a computing perspective, IoT devices may range from fairly complex (e.g., such as being embodied on a general-purpose computer system), to fairly simple (e.g., such as being embodied within a special-purpose microcontroller environment).

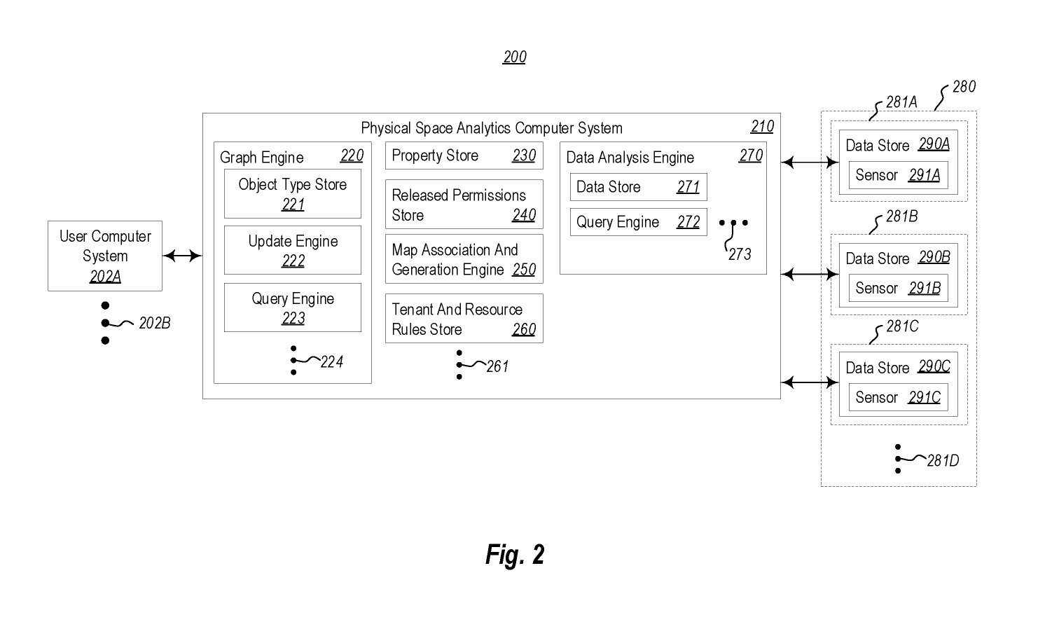

FIG. 2 illustrates an example environment 200 for providing access to sensor data from devices within a physical space. As illustrated, the environment 200 includes a user computer system 202A. The user computer system 202A may be embodied, for example, by computer system 100, as described with respect to FIG. 1. The user computer system 202A may comprise any type of computer system that is configured to communicate with, and utilize the functionality of, a server computer system 210, which is described later. In an example, the user computer system 202A may comprise a desktop computer, a laptop computer, a tablet, a smartphone, and so forth. Notably, while the environment 200 includes a single user computer system 202A, the ellipses 202B represents that any number of user computer systems may communicate with, and utilize the functionality of, the server computer system 210.

The server computer system 210 is configured to provide access to sensor data from devices (such as IoT devices) located within physical spaces (e.g., a room within a building), as further described herein. Again, the server computer system 210 may be embodied, for example, by computer system 100, as described with respect to FIG. 1. The server computer system 210 may comprise any type of computer system, including any combination of hardware and/or software that is configured to provide access to sensor data from devices located within particular physical spaces.

As shown, the server computer system 210 may include various engines, functional blocks, and components, including (as examples) a graph engine 220, a property store 230, a rules and permissions store 240, an association and generation engine 250, a tenant and resource rules store 260, and a data analysis engine 270, each of which may also include additional engines, functional blocks, and components (e.g., an object type store 221 within the graph engine 220). The various engines, components, and/or functional blocks of the server computer system 210 may be implemented on a single computer system or may be implemented as a distributed computer system that includes elements resident in a cloud environment, and/or that implement aspects of cloud computing (i.e., at least one of the various illustrated engines may be implemented locally, while at least one other engine may be implemented remotely). In addition, the various engines, functional blocks, and/or components of the server computer system 210 may be implemented as software, hardware, or a combination of software and hardware.

Notably, the configuration of the server computer system 210 illustrated in FIG. 2 is shown only for exemplary purposes. As such, the server computer system 210 may include more or less than the engines, functional blocks, and/or components illustrated in FIG. 2. In particular, the ellipses 261 represent that any number of engines, functional blocks, and/or components may be utilized within the server computer system. Although not illustrated, the various engines of the server computer system 210 may access and/or utilize a processor and memory, such as the processor 102 and the memory 104 of FIG. 1, as needed, to perform their various functions.

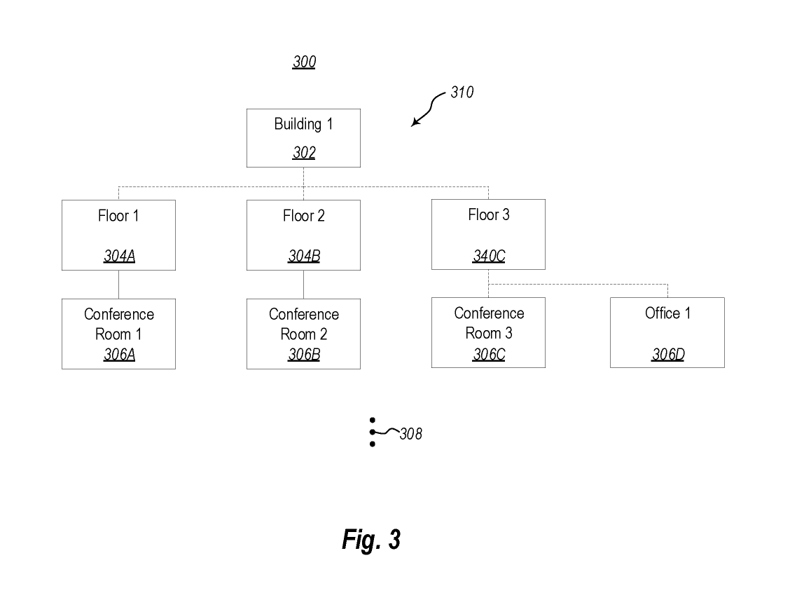

As briefly introduced, the server computer system 210 includes the graph engine 220, the property store 230, the rules and permissions store 240, the association and generation engine 250, the tenant and resource rules store 260, and the data analysis engine 270. The graph engine 220 may be configured to generate, store, and/or manage one or more hierarchical graphs (e.g., hierarchical graph 310 of FIG. 3) that defines a topology of areas and sub-areas of a physical space. For instance, FIG. 3 illustrates a hierarchical graph 310 that includes a topology of nodes associated with a physical space comprising “building 1” (e.g., building node 302). The hierarchical graph 310 also represents areas and sub-areas of “building 1,” such as different floors (i.e., floor node 304A, floor node 304B, and floor node 304C, all of which are sub-nodes of building node 302), as well as different rooms (i.e., conference room node 306A, conference room node 306B, conference room node 306C, and office node 306D) associated with each floor. Although not shown, each of the room nodes 306A-306A could be associated with additional sub-nodes representing objects in, or associated with, the rooms, such as desks, chairs, tales, computer, lab equipment, services to control the room, services to reserve the room, etc.

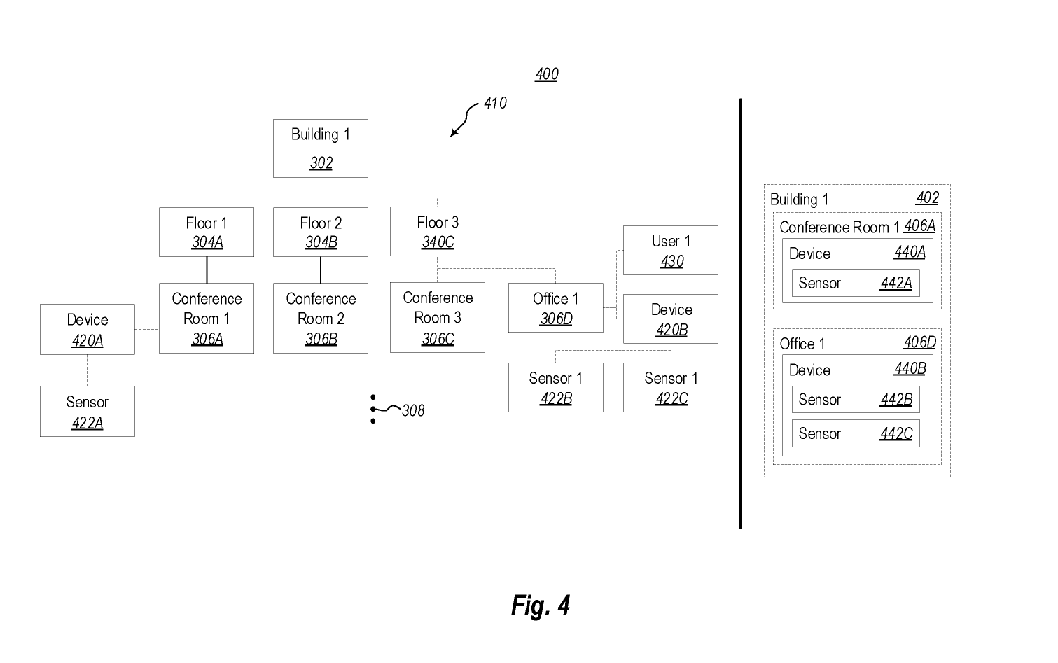

Any node in the hierarchical graph 310 could be associated with devices/sensors. For example, the various room nodes (i.e., the conference room node 306A and the office node 306D) may also be associated with devices and sensors. Similarly, FIG. 4 shows a related graph 410, that includes device nodes 420A and 420B and sensor nodes 422A-422C. While only seven nodes associated with areas/sub-areas are illustrated in FIG. 3, the ellipses 308 represents that any number of nodes that are associated with areas/sub-areas and devices/sensors may be utilized when practicing the principles described herein (whether those nodes be added or deleted in a horizontal direction (breadth) or a vertical direction (depth)). Furthermore, the topology of the graph may be continuously modified via adding or deleting nodes of the graph (in a horizontal direction or vertical direction). For instance, using the example of FIG. 3, a number of additional building nodes associated with different buildings than building 1 (corresponding to building node 302), each of which additional buildings may include additional nodes corresponding to floors, rooms, and so forth, may also be included within the graph 310.

In some embodiments, the hierarchical graph 310 may be stored within a relational database, though any type of database could be used. Additionally, regardless of the type of graph used, the full paths in the graph for each given node may be stored as metadata in the node to increase the performance and efficiency of querying the hierarchical graph 310. In this way, identification (e.g., via a query) of any ancestral node or child node (i.e., children nodes, grandchildren nodes, great-grandchildren nodes, and so on) of a given node may be performed in an order of one operation (i.e., an O(1) operation). For instance, a query that requests each node having a path that starts with “building1/floor3” (i.e., corresponding to the floor node 304C) may identify conference room 3 and office 1 (i.e., corresponding to conference room node 306C and office node 306D, respectively) as being children of the floor node 304C in an O(1) operation.

Notably, even if the conference room node 306C and the office node 306D were grandchildren, great-grandchildren, and so on, of the floor node 304C, a request for identification of each node having a path that starts with “building1/floor3” could result in identification of the conference room node 306C and the office node 306D (as well as any nodes between the floor node 304C and the conference room node 306C/the office node 306D) in an O(1) operation. Accordingly, paths associated with each node may be automatically computed and saved, which effectively tracks a primary identification for each node of the graph. While a cost is incurred upfront to generate and store each path (e.g., in connection with the addition and/or removal of one or more nodes to within the graph), the graph may be quickly and efficiently traversed to identify nodes and relationships between nodes within the graph than traditional traversing of graphs. By storing primarily static information in the graph, however, the need to generate/store these paths can be relatively infrequent.

Returning to FIG. 2, as illustrated, the graph engine 220 includes various components that may comprise any combination of appropriate hardware and/or software, including an object type store 221, an update engine 222, and a query engine 223. Notably, the ellipses 224 represents that any number of components may be included with the graph engine 220 (i.e., more or less than the components illustrated within the graph engine 220).

The object type store 221 comprises a data store of node object types that can be selected to create additional nodes within the graph 310. For instance, in addition to the node object types of buildings, floors, and rooms that are explicitly shown in FIG. 3, any number of object types associated with areas/sub-areas of physical spaces (as well as devices/sensors and individuals, as further described herein) may be used within the graph 310, including but not limited to organizations (e.g., businesses), geographic regions (e.g., continents, countries, states, cities, counties, and so forth), types of areas (e.g., buildings, farms, houses, apartments, conference rooms, offices, bathrooms, breakrooms, study areas, desks, chairs, and so forth), types of devices (e.g., thermostat, projector, paper towel dispenser, television, computer, and so forth), types of sensors (e.g., thermocouple, thermistor, humidity sensor, CO₂ sensor, Geiger counter), and so forth. Additionally, the object type store 221 may be extensible, such that additional object types may be created on demand.

The update engine 222 may be configured to update the hierarchical graph 310 with any changes made to the graph. For instance, the update engine 222 may update the graph with additional nodes, update the graph with less nodes (e.g., deleted nodes), update nodes with new or modified properties, update nodes with new or modified paths, and perform any other operations associated with modifying or updating the graph.

The query engine 223 may be configured to allow for performing queries to the hierarchical graph 310. In particular, the query engine 223 may be configured to receive queries, generate query plans, build responses to queries, and/or perform any other operations associated with receiving and responding to queries of the hierarchical graph 310.

As briefly introduced, the server computer system 210 further includes data analysis engine 270. The data analysis engine 270 may be configured to receive, gather, manage, and process data received from devices/sensors located within a physical space (associated with the hierarchical graph that defines the topology of the physical space). For instance, FIG. 2 illustrates various devices and sensors located within a physical space 280. In particular, the physical space 280 comprises various areas and sub-areas, including area/sub-area 281A, area/sub-area 281B, and area/sub-area 281C. Each of the sub-areas includes a single device having a single sensor (i.e., area/sub-area 281A includes device 290A having sensor 291A, area/sub-area 281B includes device 290B having sensor 291B, and area/sub-area 281C includes device 290C having sensor 291C). Notably, while each of the areas/sub-areas within the physical space 280 includes a single device having a single sensor, the ellipses 290 represents that there may be any number of areas/sub-areas within the physical space 280, each of the areas/sub-areas including any number of devices having any number of sensors (including zero devices/sensors).

Notably, the devices and sensors may include any type of devices/sensors, including but not limited to devices/sensors associated with detecting temperature, CO₂, light, pressure, toxic chemicals, humidity, and so forth. As such, the combination of the devices 290 (i.e., the device 290A through the device 290C) and the sensors 291 (i.e., the sensor 291A through the sensor 291C) may be configured to capture sensor data (e.g., changes in temperature) and send the captured data to the data analysis engine 270. Furthermore, “sensors” can be partially or entirely virtual. A sensor, as used herein, does not have to be a physical device, but rather a “sensor” output could be a value provided by another cloud service or API. For example, a “sensor” could output the current weather forecast for a building's location from NOAA.

The data analysis engine 270 may then be configured to receive, gather, manage, and process data received from such devices/sensors. In particular, as illustrated, the data analysis may include a data store 271 that is configured to organize, store, and allow access to received sensor data. The data store 271 may comprise any type of data store that is configured to manage dynamic, frequently changing data such as sensor data, and that provides quick and efficient performance. In an example, the data store 271 may comprise a key-value database. For instance, the data store 271 may comprise a REDIS™ CACHE. Data associated with a particular device (e.g., sensor data) may also be linked with device nodes of the hierarchical graph (e.g., the hierarchical graph 410), such that upon identification of a device node within the hierarchical graph, sensor data associated with the device corresponding to the device node may also be accessed, as further described herein.

As shown, the data analysis engine 270 further includes a query engine 272. The query engine 272 may be configured to allow for performing queries to the data store 271. In particular, the query engine 272 may be configured to receive queries, generate query plans, build responses to queries, and/or perform any other operations associated with receiving and responding to queries of the data store 271.

FIG. 4 illustrates an environment 400 including hierarchical graph 410 comprising area/sub-area nodes, as well as device/sensor nodes that are each associated with one or more area/sub-area nodes. As shown, the conference room node 306A is associated with device node 420A (having a corresponding sensor node 422A) and the office node 306D is associated with the device node 420B (having two corresponding sensor nodes, the sensor node 422B and the sensor node 422C). Additionally, FIG. 4 includes a representation of an actual physical space 402 (associated with building 1) that corresponds to the building node 302.

As illustrated, the physical space 402 also comprises conference room 406A (associated with conference room 1 and corresponding to the conference room node 306A) that includes the actual physical device 440A having the sensor 442A, as well as office 406D (associated with office 1 and corresponding to the office node 306D) that includes the actual physical device 440B having both the sensor 442B and the sensor 442C. In a specific example, the device 440A may correspond to a thermostat that includes a thermocouple (i.e., the sensor 442A) for measuring temperature. Such temperature measurements may then be sent to the data analysis engine for managing, storing, and processing the received sensor data.

Additionally, as illustrated in FIG. 4, user nodes (e.g., user node 430) may be included within the hierarchical graph 410 as being associated with one or more area/sub-area nodes. In particular, FIG. 4 shows the user node 430 being associated with the office node 306D. In a specific example, the user 1 (i.e., corresponding to the user node 330) may comprise an individual that has been assigned to office 1 (i.e., corresponding to the office node 306D).

Notably, regardless of object/node type (e.g., area/sub-area nodes, device nodes, sensor nodes, user nodes), data and/or metadata associated with the node may be stored in the hierarchical graph (e.g., the hierarchical graph 310 or the hierarchical graph 410), the data store 271 of the data analysis engine 270, or any other appropriate location associated with the server computer system 210.

As briefly introduced, the server computer system 210 further includes property store 230, rules and permissions store 240, association and generation engine 250, and tenant and resource store 260. The property store 230 may comprise a data store that includes properties associated with nodes of the hierarchical graph 310. For instance, particular properties may automatically be associated with particular object types (i.e., node types), as well as children of such object types. In a more particular example, a property associated with occupancy of a chair within a room may propagate to the room itself (i.e., showing that the room is occupied). Furthermore, as discussed with respect to the object type store 231, the property store may also be extensible, such that properties may be created and associated with any given node, and potentially associated with ancestral or children nodes of the given node.

The rules and permissions store 240 may include various rules and permissions associated with particular roles assigned to users. For instance, based on a particular role (e.g., an administrator) assigned to a user, the user may have access to perform various operations, including adding/deleting nodes, modifying nodes, accessing/modifying functionality of various devices (e.g., locking doors), and so forth.

The association and generation engine 250 may be configured to perform numerous functions with respect to associating maps with the hierarchical graph (and devices providing data to the data store), and/or generating the hierarchical graph, itself. For instance, the association and generation engine 250 may be able to generate the hierarchal graph 300 based on user input and/or based on a map. In another example, the association and generation engine 250 may be able to link nodes of the hierarchical graph to locations or devices included within a map. In yet another example, the association and generation engine 250 may further be able to generate a map based on information included within the hierarchical graph corresponding to nodes of the hierarchical graph.

The tenant and resource rules store 260 may include rules associated with how resources, permissions, properties, and so forth are to be handled for each given entity (e.g., tenant) that utilizes the hierarchical graph.

Notably, the ellipses 261 represent that the server computer system 210 may include any number of components (i.e., whether more or less) than the components illustrated within the server computer system in FIG. 2. For instance, while both the graph engine 220 and the data analysis engine 270 include corresponding query engines (i.e., the query engine 223 and the query engine 272, respectively), an overarching query engine may be included within the physical analytics computer system that allows for querying both the graph engine 220 and the data analysis engine 270. In this way, a user may be able to generate queries that can traverse the hierarchical graph (e.g., the hierarchical graph 410) to identify one or more devices associated with a particular area/sub-area of the hierarchical graph, as well as current (or previous) sensor data associated with the one or more devices via the data store 271 and the data analysis engine 270.

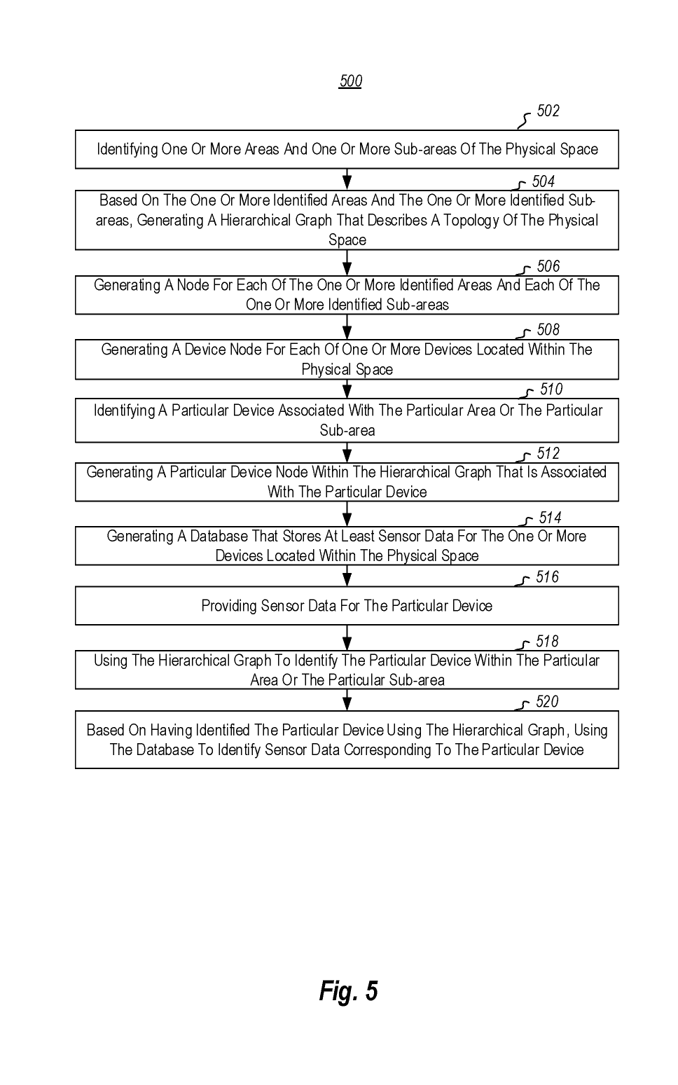

FIG. 5 illustrates a flowchart of a method 500 for providing access to sensor data from devices within a physical space. The method 500 is described with frequent reference to the environments of FIGS. 2-4. As shown, the method 500 includes identifying one or more areas and one or more sub-areas of the physical space (Act 502). For instance, the building 402, the conference room 406A, and/or the office 406D of FIG. 4 may be identified by the association and generation engine 250. The method 500 further includes, based on the one or more identified areas and the one or more identified sub-areas, generating a hierarchical graph that describes a topology of the physical space (Act 504). For instance, based on the identification of the building 402 (and its corresponding areas/sub-areas), the hierarchical graph 410 may be generated by the association and generation engine 250.

Generating the hierarchical graph further includes generating a node for each of the one or more identified areas and each of the one or more identified sub-areas (Act 506). For example, the hierarchical graph 410 includes various nodes based on an identification of areas/sub-areas associated with the building 402. Generating the hierarchical graph also includes generating a device node for each of one or more devices located within the physical space (Act 508). For instance, an identification of the device 440A and the device 440B may result in generating the device node 420A and the device node 420B, respectively.

Generating the device node for each of one or more devices located within the physical space further includes, for a particular one of the one or more areas or the one or more sub-areas, identifying a particular device associated with the particular area or the particular sub-area (Act 510). The particular device may include one or more sensors that generate data. For example, the device 440A may be identified, as well as the sensor 442A.

Generating the device node for each of one or more devices located within the physical space further includes, for a particular one of the one or more areas or the one or more sub-areas, generating a particular device node within the hierarchical graph that is associated with the particular device (Act 512). The particular device node may be a sub-node of a particular node that was generated for the particular area or the particular sub-area. For instance, the device node 420A may be generated in response to identifying the device 440A, and may further be associated with a particular area/sub-area node (i.e., the device node 420A being associated with the conference room node 306A). Additionally, any sensors associated with the device 440A may be identified, including the sensor 422A.

The method 500 further includes generating a database that stores at least sensor data for the one or more devices located within the physical space (Act 514). The database may be associated with, but separate from, the hierarchical graph. For example, the data store 271 may be generated for managing, storing, and accessing received sensor data. The method 500 may further include providing sensor data for the particular device (Act 516). For example, data from the sensor 442A of device 440A may be provided to the data store 271. In a more specific example, the sensor 442A may be configured to measure CO₂ levels, which measurements may be provided by the device 440A (or by another device capable of communicating with the device 440A) to the data store 271 (and ultimately, the data analysis engine 270).

Providing sensor data for the particular device may also include using the hierarchical graph to identify the particular device within the particular area or the particular sub-area (Act 518). For example, a query provided to the server computer system 210 (and perhaps directly to the graph engine 220) may request an identification of each device (and therefore each device node) associated with a particular area/sub-area (and therefore the particular area/sub-area node corresponding to the particular area/sub-area). Providing sensor data for the particular device may further include, based on having identified the particular device using the hierarchical graph, using the database to identify sensor data corresponding to the particular device (Act 520). For instance, upon identifying the device/device nodes (and the corresponding sensors/sensor nodes), sensor data associated with the devices/sensors may then be identified within the data store 271.

Accordingly, the principles described herein may allow for logically organizing devices (e.g., Internet of Things (IoT) devices) and/or users based on physical spaces (or areas/sub-areas of physical spaces), thus allowing for both intuitive organization, access, and control of a plurality of devices, as well as efficient use of such devices. For instance, each device associated with a particular area/sub-area (e.g., on a particular floor of a building or a particular room) may be easily shut off or placed in a reduced power state, as location-based groupings of devices are automatically created. In particular, relatively static physical space data (e.g., data regarding floors and rooms of a building) may be placed in a reliable graph (e.g., a relational database), while more dynamic sensor data may be managed in a more dynamic database (e.g., a key-value database such as a REDIS™ CACHE).

The reliability of hierarchical graph may be supplemented with quickness/efficiency by computing and storing paths associated with each node upfront when adding/removing/modifying nodes in the graph. Computing and storing the paths may then allow for performing queries with respect to ancestral nodes or child nodes of any given node in an O(1) operation. The hierarchical graph and the dynamic database may then be linked such that sensor data stored at the dynamic database may be quickly accessed when querying nodes associated with an area/sub-area within the hierarchical graph.

Referring now to FIG. 7, a graph 700 is illustrated that may be used for some embodiments of the invention. The graph 700 includes several hierarchical levels. A top node 702 is illustrated in a tenant level 704. Note that the tenant level 704 is only an example and that in other embodiments other levels may be used. In particular the example illustrated in FIG. 7 is directed to the example where a tenant of a cloud service is implemented. Note that the tenants may subdivide services provided by the cloud service to provide those services to customers of the tenant. Thus, in the example illustrated in FIG. 7, customer nodes 706 are illustrated in a customer level 708. In the example illustrated, each individual customer may have various regions where facilities for the customer are implemented. For example, the regions may be geographical regions. In the illustrated example, therefore, region nodes 710 are illustrated in a region level 712 of the hierarchical graph 700 for customer 3 illustrated in the customer level 708.

FIG. 7 further illustrates that regions may be further subdivided into venues. In this example, the venues are building numbers in a region. Thus, the hierarchical graph 700 includes venue nodes 714 in a venue level 718. For example, venue nodes 714 may each represent a building in a region of a customer of a tenant.

FIG. 7 further illustrates that a particular venue can be further subdivided into floors. Thus, FIG. 7 illustrates a floor node 718 in a floor level 720.

FIG. 7 further illustrates that a given floor can be subdivided into areas. Thus, FIG. 7 illustrates area nodes 722 in an area level 724.

A given area may be further subdivided. The example illustrated in FIG. 7 illustrates that an area may be divided into workstations, which can be further divided into desks, further divided into chairs, and so forth.

Any of the nodes in the hierarchical graph 700 can be associated with devices. Thus, for example, a given node may be associated with sensor, controller, computing system, etc. As noted above in the description of FIG. 1 through FIG. 4, sensor data can be stored in an easily accessible fashion.

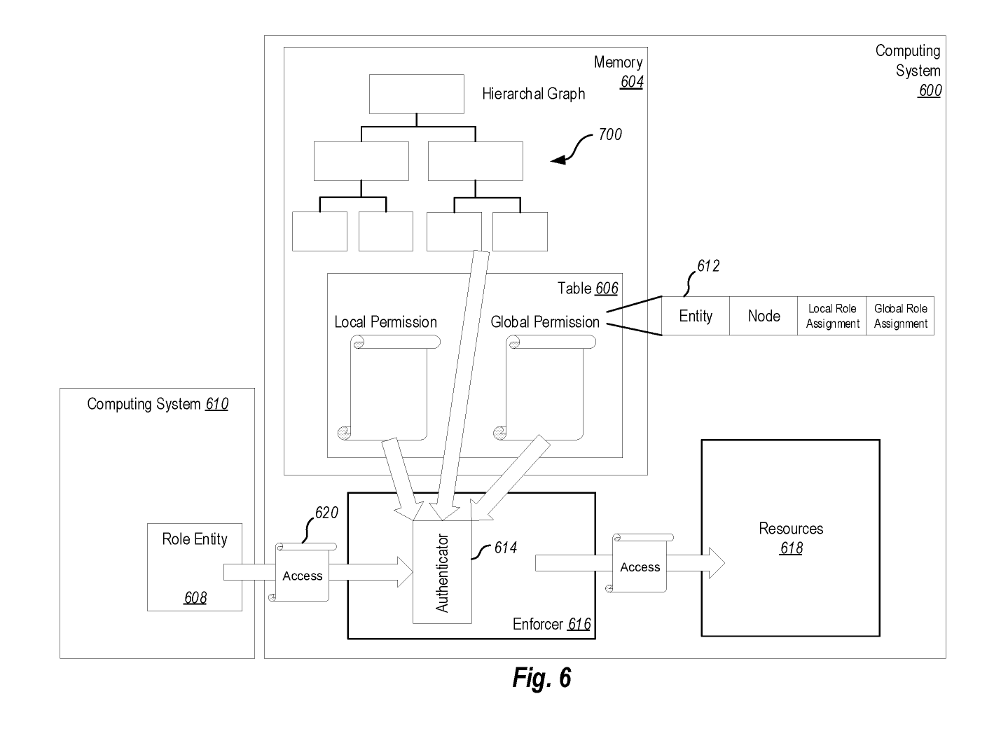

Referring now to FIG. 6, a block diagram of a system configured to enforce permissions that are a hybrid of local permissions and ancestor permissions is illustrated. The permissions are enforced based on a local role assignment to a role entity and an ancestor role assignment to a role entity.

FIG. 6 illustrates a computing system 600. The computing system may be a specific example of the computing system 100 illustrated in FIG. 1. The computing system 600 includes a memory 604 that stores a hierarchical graph 700 and role assignments. In some embodiments, the role assignments may be stored in a table, such as the table 606 illustrated in FIG. 6. Note that the memory may be implemented as one or more different storage devices. For example, the memory 604 may include various combinations of volatile memory devices, non-volatile memory devices, mass storage devices, etc. Additionally, or alternatively, the memory 604 may be implemented in a distributed fashion, such that different portions of the memory 604 are located in different physical locations.

The ancestor and local role assignments are assigned with respect to a particular node in the hierarchical graph, such as the hierarchical graph 700 illustrated in FIG. 7. That is, there is a local role assignment for a particular node and an ancestor role assignment for the same particular node. The local and ancestor role assignments are for a particular role entity. That is, the particular entity has a local role assignment at the particular node, and an ancestor role assignment at the particular node. This is illustrated by the row 612 of the table 606. The row 612 correlates, and has, a column for a particular role entity, a column for a particular node, a column for a particular local role assignment, and a column for a particular ancestor role assignment. Other rows may be implemented for other role entities. Thus, it can be seen that both local and ancestor role assignments are made at the node level, for role entities. Note that while a table is illustrated in the example, other data structures or data containers may be used to store role assignments.

Note that the role entity 608 could be an entity represented by the node (referred to herein as a node entity) or could be some other entity, such as a branch entity, user, or other entity. In one example, where the role entity is the node entity for the particular node, the ancestor and local role assignments are made for the node for building 43 in the venue level 714. The node entity associated with the node for building 43 is ‘building 43’. If building 43 has computing resources associated with it, such as the computing system 610, that are able to authenticate the node entity ‘building 43’ to an authenticator, such as the authenticator 614, the building 43 can be given local and ancestor role assignments for the node for building 43. Note that in an alternative embodiment, the branch entity, representing the node for building 43 and all nodes hierarchically below that node, can be given local and ancestor role assignments for the node for building 43. In yet another alternative embodiment a user may be given role assignments for the node for building 43.

Role assignments are used to determine permissions. A permission defines what can be done to a resource. For example, when a resource is a data object, a permission may define that a property value in the data object can be read. A different permission may define that a property value in the data object can be read and/or modified. A different permission may define that a property may be added to an object. A different permission may define that a property may be removed from an object.

In some embodiments, role assignments are rule based. For example, various rules may have dependencies on the type of role entity, the type of node for which a role assignment is made, temporal rules (e.g., time of day, week, month, or year when permissions are valid), etc. The rules may determine what permission are valid for a particular role assignment.

Thus, embodiments may include a computing system, such as the computing system comprising 600 illustrated in FIG. 6. The computing system 600 may include a memory, such as the memory 604. As noted, the memory may include volatile memory, non-volatile memory, mass storage, and/or other storage. The memory is not necessarily a singular device but may include multiple devices located in different locations that are accessible by the processors of the computer system 600.

The memory has stored thereon a hierarchical graph, such as the hierarchical graph 700. The hierarchical graph defines a topology for an entity. For example, the graph may define the geographical distribution of an entity by defining the various portions of the entity at varying levels of locational granularity. The hierarchical graph may further define devices coupled to various nodes, at various levels of the graph. Devices are generally entities capable of electronic communication. Devices may include, sensors, controllers, computing systems, and the like.

The hierarchical graph includes a top node for the entity and a number of branches coupled, through 0 or more intermediate nodes, to the top node of the entity. Each of the branches in the graph represents a sub-entity. Note that individual nodes themselves may also represent sub-entities. Thus, for example, there is a Puget Sound branch sub-entity illustrated in FIG. 7 which represents the Puget Sound node along with all of the nodes hierarchically below the Puget Sound node. There is also a Puget Sound node sub-entity that represents only the Puget Sound node.

The memory stores ancestor role assignments. Each ancestor role assignment defines one or more ancestor permissions for a given role entity at a given node in the hierarchical graph. A role entity could be any one of a number of different entities. For example, a role entity could be a node sub-entity, a branch sub-entity, a user, a device, or other entity capable of electronic communication the computing system and capable of authenticating to the computing system.

The one or more ancestor permissions apply to nodes hierarchically higher in the graph than the given node. Thus, the ancestor permissions will apply to any node that can be reached by traversing the graph in an upward direction (i.e., towards hierarchically higher nodes) from the given node without traversing downward in the graph. Thus, the role-entity can perform any actions on resources defined in the hierarchically higher nodes, so long as those actions are permitted by the permissions. The ancestor permissions do not apply to nodes hierarchically lower in the graph than the given node (i.e., able to be reached by a traversal of the graph from the given node to hierarchically lower nodes without traversing the graph upward).

The memory stores local role assignments. Each local role assignment defines one or more local permission for the given role entity at the given node in the hierarchical graph. The one or more local permissions apply to nodes hierarchically lower in the graph than the given node. Thus, for example, a local permission applied at the Puget Sound node for a particular role entity, by virtue of a role assignment, will apply to all nodes hierarchically below the given node as well.

FIG. 6 illustrates a permission enforcer 616 coupled to the memory 604. The permission enforcer 616 is configured to allow the given role entity 608 to perform actions complying with the one or more ancestor permissions for nodes hierarchically higher in the graph than the given node and to allow the given role entity to perform actions complying with the one or more local permissions for nodes hierarchically lower in the graph than the given node.

In some embodiments, at least one of the ancestor permissions or local permission is based on a role of the role entity and one or more additional conditions. For example, roles may be characteristics such as administrator, user, sensor, controller, etc. In general, a role defines a functional identity of an entity.

In one example, the one or more additional conditions may include conditions on a device type of the role entity. For example, temperature sensors may be granted different permissions than air-flow sensors.

In one example, the one or more additional conditions may include conditions on conditions on a user type of the role entity. For example, an executive user may have different permissions than an administrative assistant user.

In one example, the one or more additional conditions may include conditions on a type of the role entity. For example, sensor s may have different permissions granted than controllers.

In one example, the one or more additional conditions may include conditions on a type of the given node. For example, customer nodes may be granted different permissions than region nodes, which are granted different permissions than venue nodes, which are granted different permissions than floor nodes, etc.

In one example, the one or more additional conditions may include conditions defined by customers.

Often, embodiments will be implemented where the ancestor permissions are more restrictive than the local permission. For example, the ancestor permissions may be read only permissions, while the local permissions are read/write permission.

In some embodiments, the ancestor permissions are assigned by a larger entity (e.g., the tenant in FIG. 7) and the local permission are assigned by a sub-entity.

In some embodiments, the permission enforcer is configured to enforce a union operation on the ancestor permissions and the local permissions.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

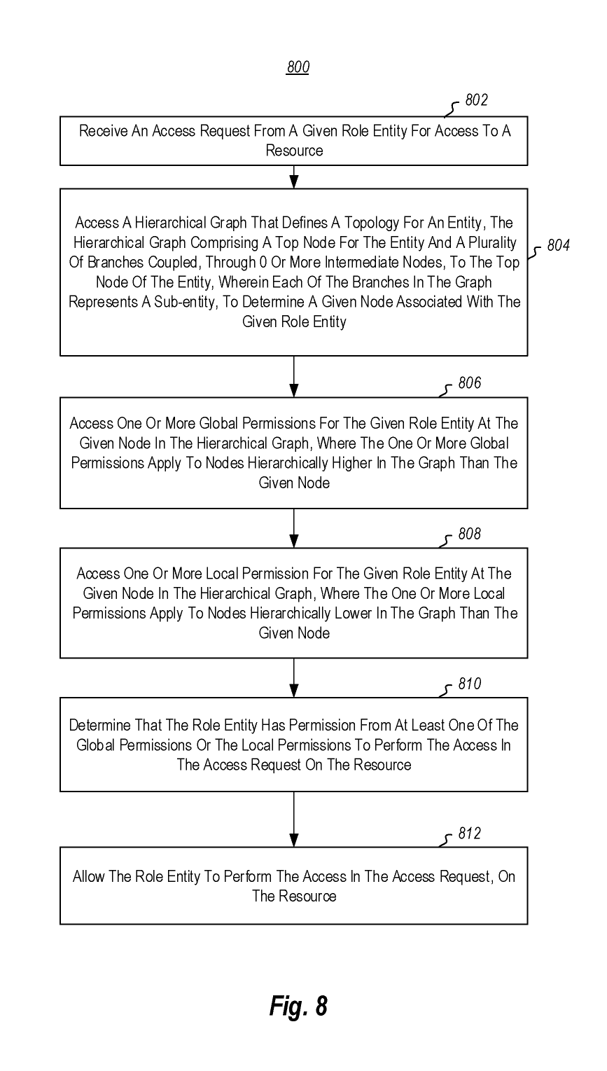

Referring now to FIG. 8, a method 800 is illustrated. The method 800 includes acts for enforcing role assignment permissions.

The method 800 includes receiving an access request from a given role entity for access to a resource (act 802). For example, as illustrated in FIG. 6, an access request 618 is received at an enforcer 616 at the computing system 600.

The method 800 further includes accessing a hierarchical graph that defines a topology for an entity, the hierarchical graph comprising a top node for the entity and a plurality of branches coupled, through 0 or more intermediate nodes, to the top node of the entity, wherein each of the branches in the graph represents a sub-entity, to determine a given node associated with the given role entity (act 804). For example, FIG. 6 illustrates the enforcer accessing the hierarchical graph 700.

The method 800 further includes accessing one or more ancestor permissions for the given role entity at the given node in the hierarchical graph, where the one or more ancestor permissions apply to nodes hierarchically higher in the graph than the given node (act 806). For example, FIG. 6 illustrates the enforcer accessing ancestor permissions from the table 606.

The method 800 further includes accessing one or more local permission for the given role entity at the given node in the hierarchical graph, where the one or more local permissions apply to nodes hierarchically lower in the graph than the given node (act 808). For example, FIG. 6 illustrates the enforcer accessing local permissions from the table 606.

The method 800 further includes determining that the role entity has permission from at least one of the ancestor permissions or the local permissions to perform the access in the access request on the resource (act 810).

The method 800 further includes as a result, allowing the role entity to perform the access in the access request, on the resource (act 812). For example, FIG. 6 illustrates the enforcer allowing the access request to be applied to the resources 620.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system comprising:
memory;
wherein the memory has stored thereon a hierarchical graph that defines a topology for an entity, the hierarchical graph comprising a top node for the entity and a plurality of branches coupled, through 0 or more intermediate nodes, to the top node of the entity, wherein each of the branches in the graph represents a sub-entity;
wherein the memory has stored thereon ancestor role assignments, wherein each ancestor role assignment defines one or more ancestor permissions for a given role entity at a given node in the hierarchical graph, where the one or more ancestor permissions apply to nodes hierarchically higher in the graph than the given node;
wherein the memory has stored thereon local role assignments, wherein each local role assignment defines one or more local permission for the given role entity at the given node in the hierarchical graph, where the one or more local permissions apply to nodes hierarchically lower in the graph than the given node;
a permission enforcer coupled to the memory, wherein the permission enforcer is configured to allow the given role entity to perform actions complying with the one or more ancestor permissions for nodes hierarchically higher in the graph than the given node and to allow the given role entity to perform actions complying with the one or more local permissions for nodes hierarchically lower in the graph than the given node.

2. The computing system of claim 1, wherein at least one of the ancestor permissions or local permission are based on a role of the role entity and one or more additional conditions.

3. The computing system of claim 2, wherein the one or more additional conditions comprise conditions on a device type of the role entity.

4. The computing system of claim 2, wherein the one or more additional conditions comprise conditions on a user type of the role entity.

5. The computing system of claim 2, wherein the one or more additional conditions comprise conditions on a type of the role entity.

6. The computing system of claim 2, wherein the one or more additional conditions comprise conditions on a type of the given node.

7. The computing system of claim 1, wherein the ancestor permissions are more restrictive than the local permission.

8. The computing system of claim 1, wherein the permission enforcer is configured to enforce a union operation on the ancestor permissions and the local permissions.

9. In a computing environment, a method of enforcing role assignment permissions, the method comprising:
receiving an access request from a given role entity for access to a resource;
accessing a hierarchical graph that defines a topology for an entity, the hierarchical graph comprising a top node for the entity and a plurality of branches coupled, through 0 or more intermediate nodes, to the top node of the entity, wherein each of the branches in the graph represents a sub-entity, to determine a given node associated with the given role entity;
accessing one or more ancestor permissions for the given role entity at the given node in the hierarchical graph, where the one or more ancestor permissions apply to nodes hierarchically higher in the graph than the given node;
accessing one or more local permission for the given role entity at the given node in the hierarchical graph, where the one or more local permissions apply to nodes hierarchically lower in the graph than the given node;
determining that the role entity has permission from at least one of the ancestor permissions or the local permissions to perform the access in the access request on the resource; and
as a result, allowing the role entity to perform the access in the access request, on the resource.

10. The method of claim 9, wherein at least one of the ancestor permissions or local permission are based on a role of the role entity and one or more additional conditions.

11. The method of claim 10, wherein the one or more additional conditions comprise conditions on a device type of the role entity.

12. The method of claim 10, wherein the one or more additional conditions comprise conditions on a user type of the role entity.

13. The method of claim 10, wherein the one or more additional conditions comprise conditions on a type of the role entity.

14. The method of claim 10, wherein the one or more additional conditions comprise conditions on a type of the given node.

15. The method of claim 9, wherein the ancestor permissions are more restrictive than the local permission.

16. The method of claim 9, wherein the ancestor permissions are assigned by the entity and the local permission are assigned by a sub-entity.

17. A computing system comprising:
one or more processors; and
one or more computer-readable media having stored thereon instructions that are executable by the one or more processors to configure the computer system to enforce role assignment permissions, including instructions that are executable to configure the computer system to perform at least the following:
receiving an access request from a given role entity for access to a resource;
accessing a hierarchical graph that defines a topology for an entity, the hierarchical graph comprising a top node for the entity and a plurality of branches coupled, through 0 or more intermediate nodes, to the top node of the entity, wherein each of the branches in the graph represents a sub-entity, to determine a given node associated with the given role entity;
accessing one or more ancestor permissions for the given role entity at the given node in the hierarchical graph, where the one or more ancestor permissions apply to nodes hierarchically higher in the graph than the given node;
accessing one or more local permission for the given role entity at the given node in the hierarchical graph, where the one or more local permissions apply to nodes hierarchically lower in the graph than the given node;
determining that the role entity has permission from at least one of the ancestor permissions or the local permissions to perform the access in the access request on the resource; and
as a result, allowing the role entity to perform the access in the access request, on the resource.

18. The computing system of claim 17, wherein at least one of the ancestor permissions or local permission are based on a role of the role entity and one or more additional conditions.

19. The computing system of claim 18, wherein the one or more additional conditions comprise conditions on a device type of the role entity.

20. The computing system of claim 18, wherein the one or more additional conditions comprise conditions on a user type of the role entity.
